(19) United States
(12) Patent Application Publication
(10) Pub. No.: US 2019/0335873 A1
(43) Pub. Date: Nov. 7, 2019

(54) Polishing and Shaping Nail File

(71) Applicant: Blazek Glass s.r.o., Podebrady (CZ)

(72) Inventor: Lenka Zdobinská, Podebrady (CZ)

(21) Appl. No.: 16/397,053

(22) Filed: Apr. 29, 2019

(30) Foreign Application Priority Data
May 3, 2018 (CZ) 2018 - 34926

(51) Int. Cl. A45D 29/04; C03C 15/00

(52) U.S. Cl. CPC A45D 29/04; C03C 15/00

(57) ABSTRACT

The polishing and shaping nail file, comprising a flat glass file body advantageously with an elongated shaped plate, one side of which has a roughened surface with a roughness ranging from 10 to 120 μm with a chemically etched micro-structure for nail shaping. The active surface on the opposite side of the file body is adapted for nail polishing and completed by a metal grid preferably composed of Chrome (Cr) or Titanium (Ti), which is formed by separated protrusions of circular facets with a thickness ranging from 0.5 to 2 μm, and with a diameter from 1.5 to 3 μm.

### FIELD

The subject of the invention is a glass file for nail polishing and shaping.

### BACKGROUND

At the present time, there are known files for nail polishing and shaping, which are resistant to the environment in which they are used. They are made of glass, they do not corrode as they comprise a monolithic glass body, their abrasive surface can be easily kept clean by rinsing with water, and they can be disinfected or sterilized. They were described in a number of patent documents, including CH 237277, CZ 693697U with analogies EP 0925003 B1, EP 1138221 B1, CA 2265866, U.S. Pat. No. 6,488,034 B1, DE 3492298234 U1, DE 69828911 T2, AU 728029 B2, FR 2765782 A3, DK 0925003 T3, ES 2165683 T3, and others. There are known glass files for nail polishing, described in Korean documents KR 101768335 B1 and KR 20150088232 A, which are fitted with metal projections fixed to the glass plate base of the file.

### SUMMARY OF THE INVENTION

An objective of the submitted technical solution is the creation of a combined glass nail file that enables an etched abrasive surface to be integrated into a single glass plate suitable for both nail shaping and polishing. It is advantageous to have an etched surface especially suitable for nail shaping on the surface opposite to the surface suitable for nail polishing; however, it is also possible to use one side of the glass plate arranged so that one area is designated for nail shaping and another area designated for nail polishing.

The invention is a nail polishing and/or shaping file, that may comprise a flat glass body, advantageously an elongated plate, one side of which has an abrasive surface with a roughness ranging from 10 to 100 μm with a chemically etched micro-structure for nail shaping. The active surface of the opposite side of the file's glass body may be adapted for nail polishing with a metal grid preferably composed of Chrome (Cr) or Titanium (Ti), or another non-corroding and inert metal. The grid pattern consists of separated protrusions, advantageously circular facets with a thickness ranging from 0.5 to 2 μm and a diameter ranging from 1.5 to 3 μm.

The glass plate of the file may have a width advantageously ranging from 8 to 20 mm and a thickness of 2 to 8 mm.

The thickness of the protrusions of the metal grid facets on the other side of the file plate is advantageously 1 μm, their diameter advantageously 2 μm.

The file body is advantageously composed of chemically or thermally hardened glass.

The etched micro-structure of the roughened surface is advantageously isotropic from one side of the file, where the average width of the elements of this etched micro-structure profile, expressed by the RSm parameter, is in the range from 150 to 300 μm and the average height of this profile, expressed by the Rc parameter, is in the range from 30 to 120 μm.

The average width of the etched micro-structure profile elements of the roughened surface of one side of the file, expressed by the RSm parameter, is advantageously 220 μm, and the average height of the profile elements, expressed by the Rc parameter, is advantageously in the range from 70 to 90 μm.

The glass file may be fitted with a handle that forms an integral part of its monolithic flat glass body. The file may be provided with a decoration selected from the group consisting of ground, engraved, painted or sandblasted decoration, printing, decal transfer, glued-on strass stones, metal, plastic or natural-stone accessories.

### BRIEF DESCRIPTION OF THE DRAWINGS

The attached drawings show examples of the design of this invention.

FIG. 1 shows the nail polishing or shaping file comprising a flat elongated glass body.

FIG. 2 shows a cross-sectional view of the file according to FIG. 1, with roughening on one of its sides.

FIG. 3 shows a cross-sectional view of the file according to FIG. 1, with roughening on one side and round edges.

FIG. 4 shows an overview of the active side of one side of the file body, which is adapted for nail polishing with the provision of a metal grid comprising separated protrusions of circular facets.

FIG. 5 shows a cross-sectional view of a part of the file's active surface according to FIG. 4.

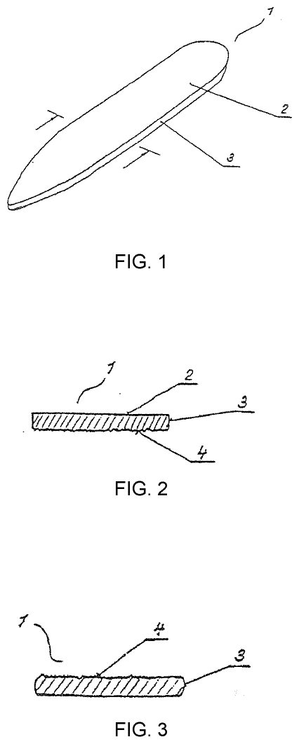

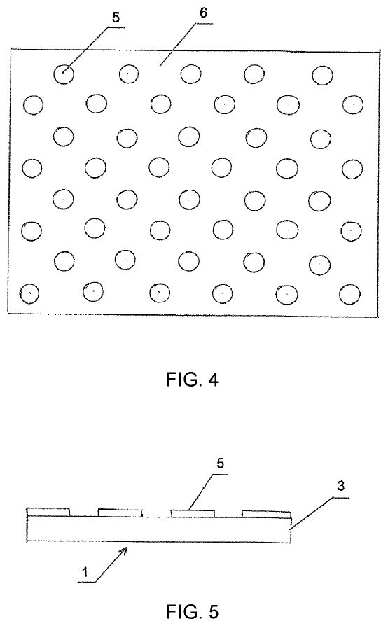

### DETAILED DESCRIPTION OF THE INVENTION

A layer of hard clean metal, advantageously Cr or Ti, or another non-corroding and inert metal, in a thickness ranging from 0.5 to 2 μm, advantageously with a thickness of 1 μm, is applied to the glass body 1 of the file made of float glass (note: the glass can be chemically or thermally hardened as far as to a matt finish, the hardened glass cannot be used prior to other operations) in the form of an elongated plate 2 with a sharp, bevelled or rounded edge 3, advantageously using a file with a width of 8 to 20 mm, with a degreased surface free from contamination, creating a pattern of circular spot facets 5 with a diameter ranging from 1.5 to 3 μm, advantageously with the diameter of 2 μm, separated by spaces from each 6. The glass plate 2 with such deposited metal forms the basis for chemical treatment of the other opposite side of the plate and the formation of an abrasive surface with a roughened surface 4 on this other side of the plate 2. The abrasive surface can also be formed on the same side of the glass plate 2 to which the metal is not applied, providing the metal is only applied to a part of it. In order to protect the metal-plated side, it is necessary to mask the metal-coated surface with an acid-resistant wax (e.g. Masking wax yellow), or an acid-resistant plastic label, or a label and wax combination. It primarily depends on the size and shape of the surface area that needs to be protected. If the file with a grip or handle is required, such handle can be covered with regular plastic adhesive tape to be removed after matting. And again, even the handle can be masked using an acid-resistant wax (e.g. Masking wax yellow). Such prepared plates 2 are then matted in a mixture of hydrofluoric and sulphuric acids.

The formation of an abrasive surface on the other side of the plate or on a part of the same non-metal surface is to be created by etching, whereas the etched micro-structure of the roughened surface 4 is isotropic. The average width of the elements of this etched micro-structure profile, expressed by the RSm parameter, is in the range of 150 to 300 μm, and the average height of the profile elements, expressed by the Rc parameter, is in the range of 30 to 120 μm.

The average width of the etched micro-structure profile elements of the roughened surface 4, expressed by the RSm parameter, is advantageously 220 μm, and the average height of the profile elements, expressed by the Rc parameter, is in the range of 70 to 90 μm.

The masking wax or label needs to be removed after the abrasive surface etching.

The glass plate 2 can advantageously be thermally or chemically tempered (hardened), which achieves a higher resistance to fracture or breakage.

The glass file can be provided with a decoration selected from the group consisting of ground, engraved, painted or sand-blasted decoration, printing, decal transfer, glued-on rhinestones, jewels, metal, plastic or natural-stone accessories.

A combined file with a polisher produced in this way has the extraordinary properties of a glass file and simultaneously an effective nail polisher, which can advantageously also be used to polish the nail edges making them fully smooth, split-free, and much more resistant to eventual nail infections.

What is claimed is:

1. The polishing and shaping nail file, comprising a flat glass file body (1) advantageously with an elongated shaped plate (2), one side of which has a roughened surface (4) with a roughness ranging from 10 to 120 μm with a chemically etched micro-structure for nail shaping, characterized in that the active surface on the opposite side of the file body (1) is adapted for nail polishing and completed by a metal grid preferably composed of Chrome (Cr) or Titanium (Ti), which is formed by separated protrusions of circular facets (5) with a thickness ranging from 0.5 to 2 μm, and with a diameter from 1.5 to 3 μm.

2. The polishing and shaping nail file, comprising a flat glass file body (1) advantageously of elongated shaped plate (2), one side of which has a partially roughened surface (4) with roughness ranging from 10 to 120 μm with a chemically etched micro-structure for nail shaping, characterized in that the active surface on the same side of the file body (1) is adapted for nail polishing and completed by a metal grid preferably composed of Chrome (Cr) or Titanium (Ti), which is formed by separated protrusions of circular facets (5) with a thickness ranging from 0.5 to 2 μm and with a diameter from 1.5 to 3 μm.

3. The file according to claim 1 or 2, characterized in that the glass shaped plate (2) has a width ranging from 8 to 20 mm.

4. The file according to claim 1 or 2, characterized in that the thickness of the metal grid protrusions of facets (5) is 1 μm, with a diameter of 2 μm.

5. The file according to claim 1 or 2, characterized in that the body (1) is composed of chemically or thermally hardened glass.

6. The file according to claim 1 or 2, characterized in that the etched micro-structure of the roughened surface (4) is isotropic, where the average width of the etched micro-structure profile elements, expressed by the RSm parameter, is in the range of 150 to 300 μm, and the average height of the profile elements, expressed by the Rc parameter, is in the range of 30 to 120 μm.

7. The file according to claim 1 or 2, characterized in that the average width of the etched micro-structure profile elements of the roughened surface (4), expressed by the RSm parameter, being 220 μm, and the average height of the profile elements, expressed by the Rc parameter, in the range of 70 to 90 μm.

8. The file according to claim 1, characterized in that it is fitted with a handle that forms an integral part of its monolithic flat glass file body (1).

9. The file according to claim 1 or 2, characterized in that the file is provided with a decoration selected from the group consisting of ground, engraved, painted or sand-blasted decoration, printing, decal transfer, glued-on rhinestones, jewels, metal, plastic or natural-stone accessories.
